(19) United States
(12) Patent Application Publication
(10) Pub. No.: US 2014/0324830 A1
(43) Pub. Date: Oct. 30, 2014

(54) SYSTEM AND METHOD FOR MANAGING RELATED INFORMATION OF MULTIMEDIA PROGRAMS

(71) Applicant: HON HAI PRECISION INDUSTRY CO., LTD., New Taipei (TW)

(72) Inventors: YI-WEN CAI, New Taipei (TW); CHUN-MING CHEN, New Taipei (TW); CHUNG-I LEE, New Taipei (TW)

(73) Assignee: HON HAI PRECISION INDUSTRY CO., LTD., New Taipei (TW)

(21) Appl. No.: 13/972,954

(22) Filed: Aug. 22, 2013

(30) Foreign Application Priority Data
Apr. 24, 2013 (TW) 102114581

(51) Int. Cl. G06F 17/30

(52) U.S. Cl. CPC G06F 17/30554
USPC 707/722

(57) ABSTRACT

A method for a first electronic device and a second electronic device to manage related information of a multimedia program. The method obtains decoded data of ultrasound signals when the first electronic device receives the ultrasound signals from the second electronic device. The method further receives a query keyword input from the first electronic device. When the received query keyword matches the decoded data, the related information of the multimedia program is displayed on the first electronic device.

### BACKGROUND

1. Technical Field

Embodiments of the present disclosure relate to management technology, and particularly to a system and a method for managing related information of multimedia programs.

2. Description of Related Art

It is helpful to be able to query data instantly using an electronic device (e.g. a tablet computer). The electronic device can query related information of multimedia programs played by a television (TV), such as, brief introduction, reviews and network links, for example. However, a network is needed for the portable device to obtain and query the related information. It is not presently convenient or immediate for users to obtain and query the related information.

### BRIEF DESCRIPTION OF THE DRAWINGS

FIG. 1 is a schematic diagram of one embodiment of a first electronic device and a second electronic device including a management system.

FIG. 2 is a block diagram of one embodiment of function modules of the management system in the first electronic device and the second electronic device in FIG. 1.

FIG. 3 shows a schematic diagram illustrating one embodiment of a packet of related information.

FIG. 4 is a flowchart illustrating one embodiment of a method of transmitting related information of a multimedia program.

FIG. 5 is a flowchart illustrating one embodiment of a method of receiving the related information of the multimedia program.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

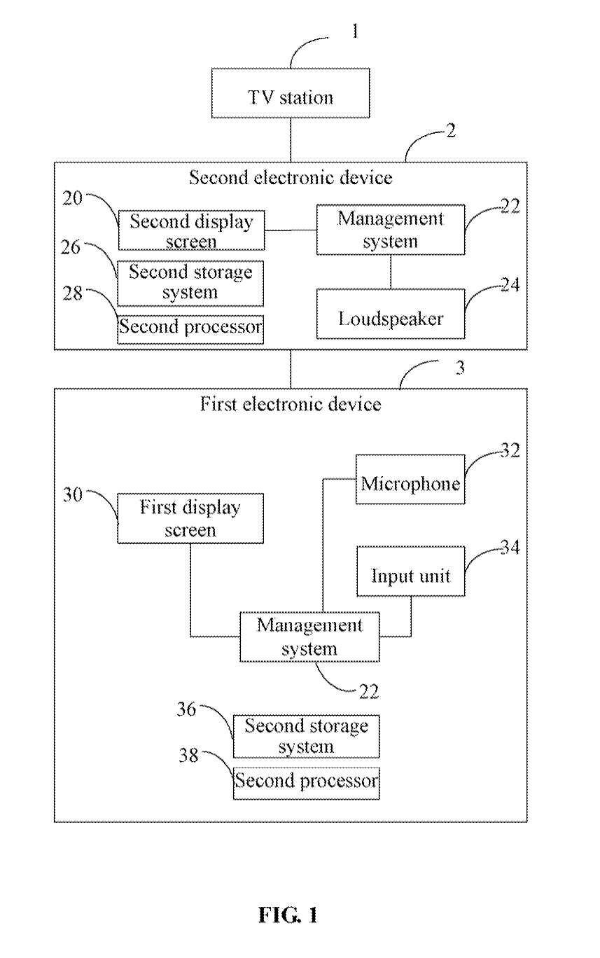

FIG. 1 is a schematic diagram of one embodiment of a first electronic device 3 and a second electronic device 2. The first electronic device 3 and the second electronic device 2 both include a management system 22. In one embodiment, the first electronic device 3 is a portable device such as a tablet computer, a smart phone, or a notebook computer. The second electronic device 2 is a display device such as a television or a computer monitor. The second electronic device 2 communicates with a television (TV) station 1 through a wireless connection using an antenna, or a wired connection using cables, for example. The second electronic device 2 receives multimedia programs from the TV station 1. The multimedia programs are TV programs or television advertisements. In other embodiments, the second electronic device 2 receives the multimedia programs from a server.

The second electronic device 2 includes a second display screen 20 and a loudspeaker 24, a second storage system 26, and a second processor 28. The second display screen 20 displays the multimedia programs received by the second electronic device 2. The loudspeaker 24 may output sound that can be heard by human ears, and further output ultrasound signals that cannot be heard by human ears.

The first electronic device 3 includes a first display screen 30, a microphone 32, an input unit 34, a first storage system 36, and a first processor 38. The microphone 32 receives the ultrasound signals outputted by the loudspeaker 24, and receives all other sounds. The input unit 34 may be a virtual keyboard or a physical keyboard.

For simplification, in the embodiment, the second electronic device 2 is considered as a sender device for sending related information of multimedia programs, and the first electronic device 3 is considered as a receiver device for receiving the related information of the multimedia programs from the second electronic device 2. The related information of the multimedia programs may be included in the multimedia programs, or may be provided independently by the TV station 1. In another embodiment, the first electronic device 3 is the receiver device, and the second electronic device 2 is the sender device. The management system 22 may send and receive related information of the multimedia programs between the first electronic device 3 and the second electronic device 2, and provide the related information according to a query request.

The first storage system 36 and the second storage system 26 store data for their respective electronic devices. The first storage system 36 or the second storage system 26 may be a memory, an external storage card, such as a smart media card, or a secure digital card. Both of the first processor 38 and the second processor 28 execute one or more computerized codes and other applications for their respective devices, to provide the functions of the management system 22.

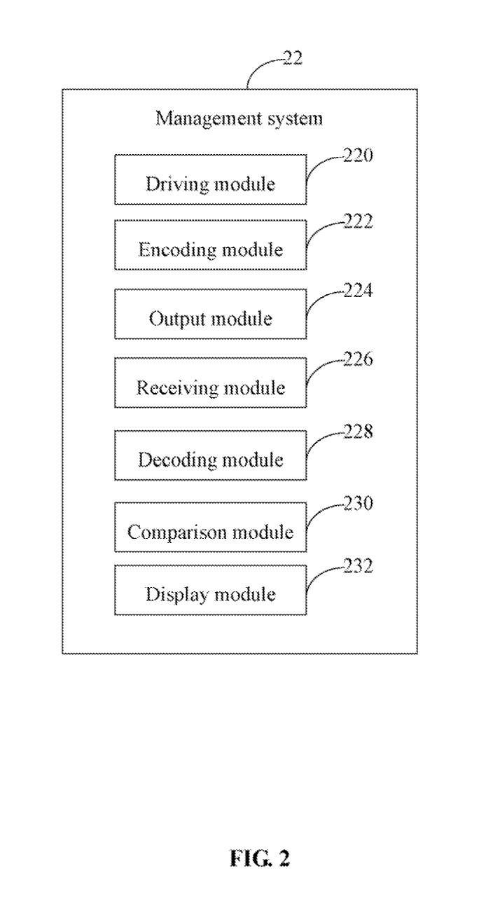

FIG. 2 is a block diagram of function modules of the management system 22 in the first electronic device 3 and in the second electronic device 2 of FIG. 1. In the embodiment, the management system 22 may include a driving module 220, an encoding module 222, an output module 224, a receiving module 226, a decoding module 228, a comparison module 230, and a display module 232. The modules 220, 222, 224, 226, 228, 230, and 232 comprise computerized codes in the form of one or more programs that may be stored in each of the first storage system 36 and the second storage system 26. The computerized code includes instructions that are executed by the first processor 38 or by the second processor 28 to provide functions for the modules.

In one embodiment, if the second electronic device 2 is the sender device, the second electronic device 2 runs the modules 220, 222 and 224 to send the related information. If the first electronic device 3 is the receiver device, the first electronic device 3 runs the modules 226, 228, 230 and 232 to receive the related information. Details of these operations follow.

When the second electronic device 2 receives a multimedia program from the TV station 1, the driving module 220 drives the second display screen 20 to display images of the multimedia program, and drives the loudspeaker 24 to output audio of the multimedia program.

The encoding module 222 obtains related information of the received multimedia program, and encodes the related information. The encoding module 222 further converts the encoded related information into ultrasound signals. In one embodiment, the related information of the multimedia program includes, but is not limited to, specific nouns of the multimedia program (e.g. a program name, persons name, place names, names of scenic spots highlighted in the multimedia program), and content descriptions of the specific nouns (e.g. brief introductions, extended information, or network links about the specific nouns).

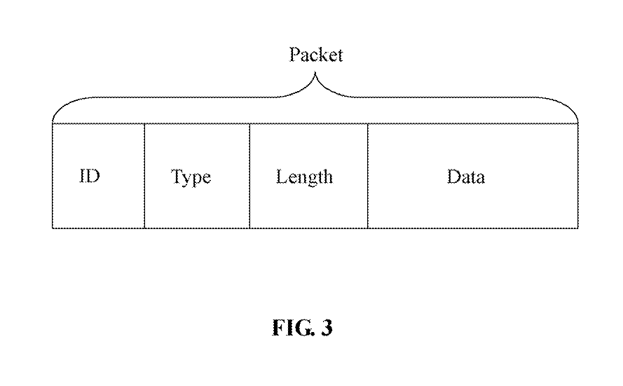

In one embodiment, the encoding module 222 encodes the obtained related information into a packet, and converts the packet of the related information into ultrasound signals using a preset modulation method, such as an orthogonal frequency-division multiplexing (OFDM) method. FIG. 3 is a schematic diagram illustrating one embodiment of a packet of the related information. The packet includes, but is not limited to, an identification (ID) field, a type field, a length field, and a data field. The ID field stores an identifier of the packet to represent the related information. The type field stores the specific nouns in the multimedia program. The data field stores the content description of the specific nouns. The length field stores a length of the data field.

The output module 224 outputs the ultrasound signals to the first electronic device 3 using the loudspeaker 24.

The receiving module 226 receives ultrasound signals using the microphone 32 from the second electronic device 2, for example, receiving the converted ultrasound signals.

The decoding module 228 obtains decoded data (e.g. the packet of the related information) of the received ultrasound signals by decoding the received ultrasound signals according to the preset modulation method.

When a query keyword is inputted using the input unit 34, the comparison module 230 determines whether the query keyword matches the decoded data by comparing the query keyword with specific nouns in the type field of the decode data. In one embodiment, if the query keyword is the same as one of the specific nouns, the comparison module 230 determines that the decoded data matches the query keyword. If the query keyword is different from each of the specific nouns, the comparison module 230 determines that the decoded data does not match the query keyword.

When the query keyword matches the decoded data, the display module 232 displays related information of the decoded data on the first display screen 30. In one embodiment, the display module 232 displays content description in the data field of the decoded data.

When the query keyword does not match the decoded data, the display module 232 further displays a failure message of the query keyword on the first display screen 30. For example, the failure message is represented as “no matched related information, please reenter a query keyword”.

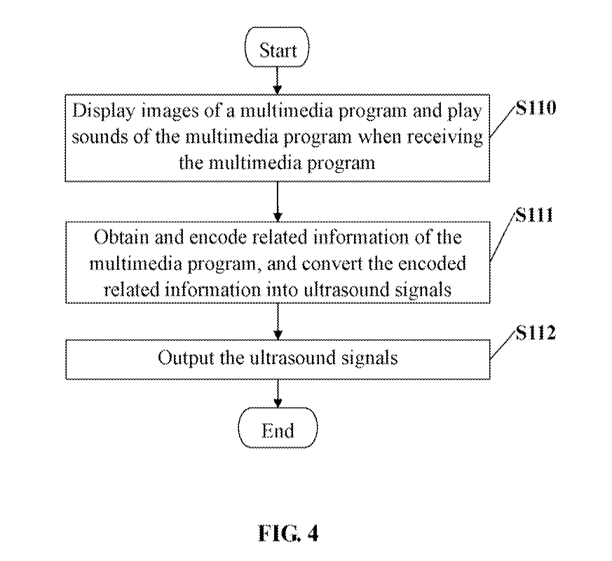

FIG. 4 is a flowchart illustrating one embodiment of a method of transmitting related information of a multimedia program. Depending on the embodiment, additional steps may be added, others deleted, and the ordering of the steps may be changed.

In step S110, when the second electronic device 2 receives a multimedia program from the TV station 1, the driving module 220 drives the second display screen 20 to display images of the multimedia program, and drives the loudspeaker 24 to play audio of the multimedia program.

In step S111, the encoding module 222 obtains and encodes related information of the received multimedia program, and converts the encoded related information into ultrasound signals. In one embodiment, the related information of the multimedia program may include, but is not limited to, specific nouns of the multimedia program, and content descriptions of the specific nouns. The encoding module 222 encodes the obtained related information into a packet, which stores an identifier of the packet to represent the related information, the specific nouns in the multimedia program, the content description of the specific nouns, and the length of the content description.

In step S112, the output module 224 outputs the converted ultrasound signals to the first electronic device 3 using the loudspeaker 24.

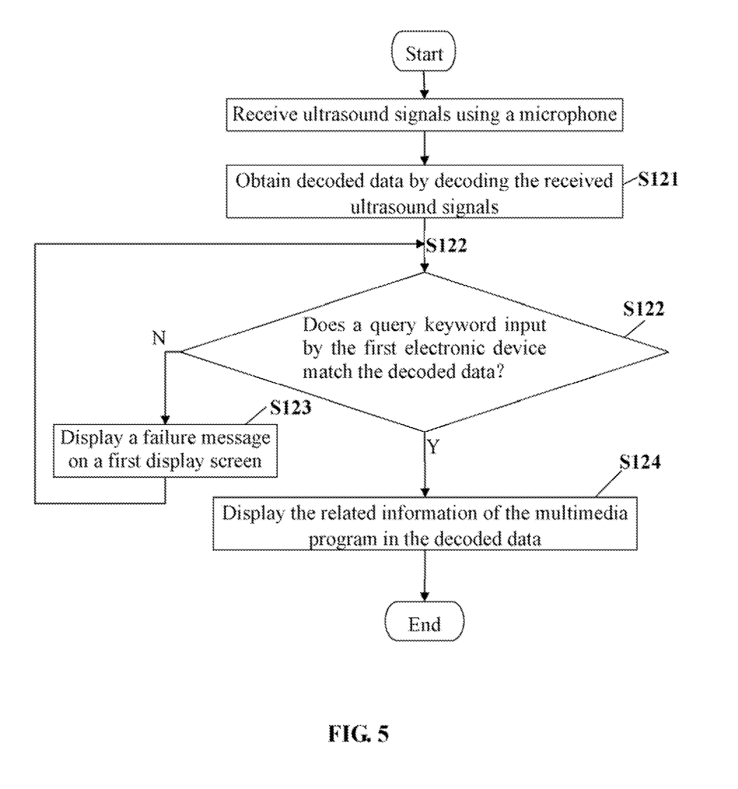

FIG. 5 is a flowchart illustrating one embodiment of a method of receiving the related information of the multimedia program. Depending on the embodiment, additional steps may be added, others deleted, and the ordering of the steps may be changed.

In step S120, through the microphone 32, the receiving module 226 receives ultrasound signals from the second electronic device 2.

In step S121, the decoding module 228 obtains decoded data (e.g. the packet of the related information) of the received ultrasound signals by decoding the received ultrasound signals according to the preset modulation method.

In step S122, when a query keyword is input into the input unit 34, the comparison module 230 determines whether the received query keyword matches the decoded data by comparing the query keyword with specific nouns in a type field of the decode data. In one embodiment, if the query keyword is the same as one of the specific nouns, the comparison module 230 determines that the decoded data matches the query keyword, and step S124 is implemented. If the query keyword is different from each of the specific nouns in the decoded data, the comparison module 230 determines that the query keyword does not match the decoded data, and step S123 is implemented.

In step S123, the display module 232 displays a failure message of the query keyword on the first display screen 30, and step S122 is repeated when a next query keyword is input.

In step S124, the display module 232 displays related information of the decoded data on the first display screen 30. In one embodiment, the display module 232 displays content description in a data field of the decoded data.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and protected by the following claims.

What is claimed is:

1. A computer-implemented method for managing related information of a multimedia program using a first electronic device and a second electronic device, the method comprising:
obtaining decoded data of ultrasound signals by decoding the ultrasound signals according to a preset modulation method, when the first electronic device receives the ultrasound signals from the second electronic device using a microphone of the first electronic device;
receiving a query keyword input from the first electronic device;
determining whether the received query keyword matches the decoded data; and
displaying related information of a multimedia program in the decoded data on a display screen of the first electronic device, when the received query keyword matches the decoded data.

2. The method as described in claim 1, further comprising:
encoding the related information of the multimedia program by the second electronic device, when the second electronic device receives the multimedia program from a television station in communication with the second electronic device;
converting the encoded related information into the ultrasound signals by the second electronic device according to the preset modulation method; and
outputting the ultrasound signals to the first electronic device by the second electronic device.

3. The method as described in claim 2, wherein the related information is encoded into a packet which stores an identifier of the packet to represent the related information, specific nouns in the multimedia program, content descriptions of the specific nouns, and a length of the content descriptions.

4. The method as described in claim 3, wherein the content descriptions of the specific nouns in the decoded data is displayed when the received query keyword matches the decoded data.

5. The method as described in claim 1, furthering comprising:
displaying a failure message of the received query keyword on the display screen, when the received query keyword does not match the decoded data.

6. The method as described in claim 3, further comprising:
determining that the received query keyword matches the decoded data, when the received query keyword is the same as one of the specific nouns in the decoded data; or
determining that the received query keyword does not match the decoded data, when the received query keyword is different from each of the specific nouns in the decoded data.

7. An electronic device for managing related information of a multimedia program, the electronic device comprising:
at least one processor; and
a computer-readable storage medium storing one or more programs, which when executed by the at least one processor, the one or more programs comprising causes the at least one processor to:
obtain decoded data of ultrasound signals by decoding the ultrasound signals according to a preset modulation method, when the electronic device receives the ultrasound signals from a sender device using a microphone of the electronic device;
receive a query keyword input from the electronic device;
determine whether the received query keyword matches the decoded data;
display related information of a multimedia program in the decoded data on a display screen of the electronic device, when the received query keyword matches the decoded data.

8. The electronic device as described in claim 7, wherein the one or more programs further comprising causes the at least one processor to:
encode the related information of the multimedia program, when the multimedia program is received from a television station in communication with the electronic device;
convert the encoded related information into the ultrasound signals according to the preset modulation method;
output the ultrasound signals.

9. The electronic device as described in claim 8, wherein the related information is encoded into a packet which stores an identifier of the packet to represent the related information, specific nouns in the multimedia program, content descriptions of the specific nouns, and a length of the content descriptions.

10. The electronic device as described in claim 9, wherein the content descriptions of the specific nouns in the decoded data is displayed when the received query keyword matches the decoded data.

11. The electronic device as described in claim 7, wherein the one or more programs further comprising causes the at least one processor to:
display a failure message of the received query keyword on the display screen, when the received query keyword does not match the decoded data.

12. The electronic device as described in claim 10, wherein the received query keyword is determined to match the decoded data, when the received query keyword is the same as one of the specific nouns in the decoded data; or
the received query keyword is determined to not match the decoded data, when the received query keyword is different from each of the specific nouns in the decoded data.

13. A non-transitory computer readable storage medium having stored thereon instructions that, when executed by a first electronic device and a second electronic device, causes the first and the second electronic device to perform a method for managing related information of a multimedia program, the method comprising:
obtaining decoded data of ultrasound signals by decoding the ultrasound signals according to a preset modulation method, when the first electronic device receives the ultrasound signals from the second electronic device;
receiving a query keyword input from the first electronic device;
determining whether the received query keyword matches the decoded data; and
displaying related information of a multimedia program in the decoded data on a display screen of the first electronic device, when the received query keyword matches the decoded data.

14. The non-transitory computer readable storage medium as described in claim 13, further comprising:
encoding the related information of the multimedia program by the second electronic device, when the second electronic device receives the multimedia program from a television station in communication with the second electronic device;
converting the encoded related information into the ultrasound signals by the second electronic device according to the preset modulation method; and
outputting the ultrasound signals to the first electronic device by the second electronic device.

15. The non-transitory computer readable storage medium as described in claim 14, wherein the related information is encoded into a packet which stores an identifier of the packet to represent the related information, specific nouns in the multimedia program, content descriptions of the specific nouns, and a length of the content descriptions.

16. The non-transitory computer readable storage medium as described in claim 15, wherein the content descriptions of the specific nouns in the decoded data is displayed when the received query keyword matches the decoded data.

17. The non-transitory computer readable storage medium as described in claim 13, furthering comprising:
display a failure message of the received query keyword on the display screen, when the received query keyword does not match the decoded data.

18. The non-transitory computer readable storage medium as described in claim 15, further comprising:
determining that the received query keyword matches the decoded data, when the received query keyword is the same as one of the specific nouns in the decoded data; or
determining that the received query keyword does not match the decoded data, when the received query keyword is different from each of the specific nouns in the decoded data.
